(19) United States
(12) Patent Application Publication
(10) Pub. No.: US 2022/0284363 A1
(43) Pub. Date: Sep. 8, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Seiichiro HIRATSUKA, Kanagawa (JP); Kengo TOKUCHI, Kanagawa (JP); Kosuke AOKI, Kanagawa (JP); Kosuke TOMOKUNI, Kanagawa (JP); Makoto TORIYAMA, Kanagawa (JP)

(73) Assignee: FUJIFILM Business Innovation Corp., Tokyo (JP)

(21) Appl. No.: 17/374,548

(22) Filed: Jul. 13, 2021

(30) Foreign Application Priority Data
Mar. 8, 2021 (JP) 2021-036212

(51) Int. Cl. G06Q 10/06

(52) U.S. Cl. CPC G06Q 10/06311

(57) ABSTRACT

An information processing apparatus includes a processor configured to: correlate user groups each constituted from users that are present at plural locations in a real space with regions in a virtual space in which movement between the regions is allowed; and display, when a user has moved between the regions in the virtual space, images related to users that constitute a user group correlated with a region as a movement destination in display ranges specified for the users, respectively, and display an image related to the user who has moved in a display range for the user who has moved.

### CROSS-REFERENCE TO RELATED APPLICATIONS

This application is based on and claims priority under 35 USC 119 from Japanese Patent Application No. 2021-036212 filed Mar. 8, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2011-216073 describes a technique of collecting unique static information and dynamic information, such as an action history, of an avatar and analyzing the information to use the information for marketing when conducting business utilizing a three-dimensional virtual space.

### SUMMARY

In recent years, the way of working for a company has been diversified, and telework which allows people to work at places other than an office building in which their workplace is located, such as their personal residences, has been introduced in addition to a work system that requires people to work on site in the office building. Along with this trend, groupware such as Web conference systems has been spread in recent years as tools for communication among employees that work at a plurality of locations.

When an employee actually works on site in an office building in which office spaces are present on a plurality of floors, a certain user may move from a floor that the user is presently on to a different floor to communicate with users that are on the destination floor. There are also users that are not the communication target on the destination floor, and the user who has moved from a different floor may grasp information such as the work status of such users.

However, the current groupware is capable of displaying only users invited to a group on a screen, and therefore allows users to grasp limited information on the types of users compared to the case where the users work on site in the office building.

Aspects of non-limiting embodiments of the present disclosure relate to enabling users that belong to a workplace to communicate with each other from a plurality of locations without working on site at the workplace, while allowing the users to grasp information on users that belong to the workplace as in the case where the users work on site at the workplace.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: correlate user groups each constituted from users that are present at a plurality of locations in a real space with regions in a virtual space in which movement between the regions is allowed; and display, when a user has moved between the regions in the virtual space, images related to users that constitute a user group correlated with a region as a movement destination in display ranges specified for the users, respectively, and display an image related to the user who has moved in a display range for the user who has moved.

### BRIEF DESCRIPTION OF THE DRAWINGS

An exemplary embodiment of the present disclosure will be described in detail based on the following figures, wherein:

FIG. 1 illustrates a schematic configuration of an information processing system;

FIG. 2 is a block diagram illustrating the hardware configuration of an information processing apparatus;

FIG. 3 is a block diagram illustrating the hardware configuration of a user terminal;

FIG. 4 is a flowchart illustrating the flow of a display process performed by the information processing apparatus;

FIG. 5 illustrates a first display example of a virtual office;

FIG. 6 is a flowchart illustrating the flow of a movement process performed by the information processing apparatus;

FIG. 7 illustrates an example of a permissive floor table;

FIG. 8 illustrates a second display example of the virtual office;

FIG. 9 illustrates a third display example of the virtual office;

FIG. 10 illustrates a fourth display example of the virtual office;

FIG. 11 illustrates a fifth display example of the virtual office;

FIG. 12 illustrates a sixth display example of the virtual office;

FIG. 13 illustrates an example of display on the user terminal;

FIG. 14 illustrates a seventh display example of the virtual office; and

FIG. 15 illustrates an eighth display example of the virtual office.

### DETAILED DESCRIPTION

An information processing system 10 according to the present exemplary embodiment will be described below.

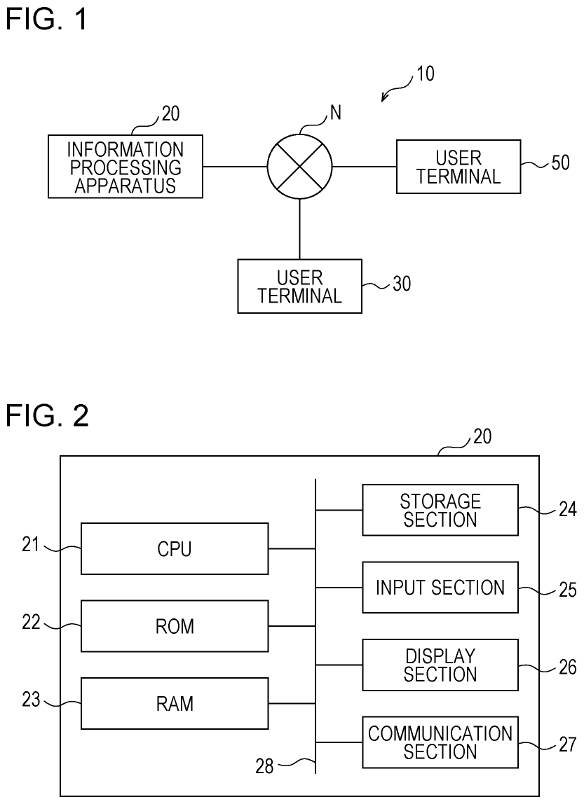

FIG. 1 illustrates a schematic configuration of the information processing system 10.

As illustrated in FIG. 1, the information processing system 10 includes an information processing apparatus 20, a user terminal 30, and a user terminal 50. The information processing apparatus 20, the user terminal 30, and the user terminal 50 are connected via a network N to be able to communicate with each other. The network N may be the Internet, a Local Area Network (LAN), a Wide Area Network (WAN), etc., for example.

The information processing apparatus 20 provides a virtual office that is built on a computer and that simulates the real space, the virtual office enabling users that belong to a workplace to communicate with each other from a plurality of locations without working on site in an office building in which their workplace is located, while allowing the users to grasp information on users that belong to the workplace as in the case where the users work on site in the office building. The virtual office is a “world” in the virtual reality that is built on a computer and that simulates an office in the real space. The office building is assumed to have an office space that is present on a plurality of floors. The virtual office is an example of the “virtual space defined on a computer”.

The user terminal 30 is a terminal of a user that works in the office building in which his/her workplace is located. The virtual office may be used from the user terminal 30.

The user terminal 50 is a terminal of a user that works at a telework site other than the office building in which his/her workplace is located. The virtual office may be used from the user terminal 50. The telework site may include a personal residence of the user, a cafe, a shared office, etc., by way of example.

FIG. 2 is a block diagram illustrating the hardware configuration of the information processing apparatus 20. The information processing apparatus 20 may be a general-purpose computer device such as a server computer and a personal computer, or a portable terminal such as a smartphone and a tablet terminal, by way of example. In the present exemplary embodiment, the information processing apparatus 20 is a “server computer”.

As illustrated in FIG. 2, the information processing apparatus 20 includes a Central Processing Unit (CPU) 21, a Read Only Memory (ROM) 22, a Random Access Memory (RAM) 23, a storage section 24, an input section 25, a display section 26, and a communication section 27. The various components are communicably connected to each other via a bus 28. The CPU 21 is an example of the “processor”.

The CPU 21 is a central processing unit, and executes various programs and controls various sections. That is, the CPU 21 reads programs from the ROM 22 or the storage section 24, and executes the programs using the RAM 23 as a work area. The CPU 21 controls the various components described above and performs various computation processes in accordance with the programs stored in the ROM 22 or the storage section 24. In the present exemplary embodiment, the ROM 22 or the storage section 24 stores an information processing program for executing at least a display process and a movement process to be discussed later. The information processing program may be installed in advance in the information processing apparatus 20, or may be stored in a non-volatile storage medium, or distributed via the network N, to be installed, as appropriate, in the information processing apparatus 20. Examples of the non-volatile storage medium are assumed to include a Compact Disc Read Only Memory (CD-ROM), a magneto-optical disk, a Hard Disk Drive (HDD), a Digital Versatile Disc Read Only Memory (DVD-ROM), a flash memory, and a memory card.

The ROM 22 stores various programs and various data. The RAM 23 serves as a work area to temporarily store the programs and the data.

The storage section 24 is constituted as a storage device such as an HDD, a Solid State Drive (SSD), and a flash memory, and stores various programs including an operating system and various data.

The input section 25 includes a pointing device such as a mouse, various buttons, a keyboard, a microphone, a camera, etc., for example, and is used to make various inputs.

The display section 26 may be a liquid crystal display, for example, and displays various types of information. The display section 26 may adopt a touch screen to also function as the input section 25. The display section 26 may display a virtual office using an Augmented Reality (AR) function to superpose the virtual office on an image of the real space, or may display a virtual office using a Virtual Reality (VR) function to switch an image in accordance with the direction of the viewing field of the user or motion of the head portion of the user.

The communication section 27 is an interface for communication with a different device. The communication uses a standard for wired communication such as Ethernet (registered trademark) and Fiber-optic Data Distribution Interface (FDDI), or a standard for wireless communication such as 4G, 5G, and Wi-Fi (registered trademark), for example.

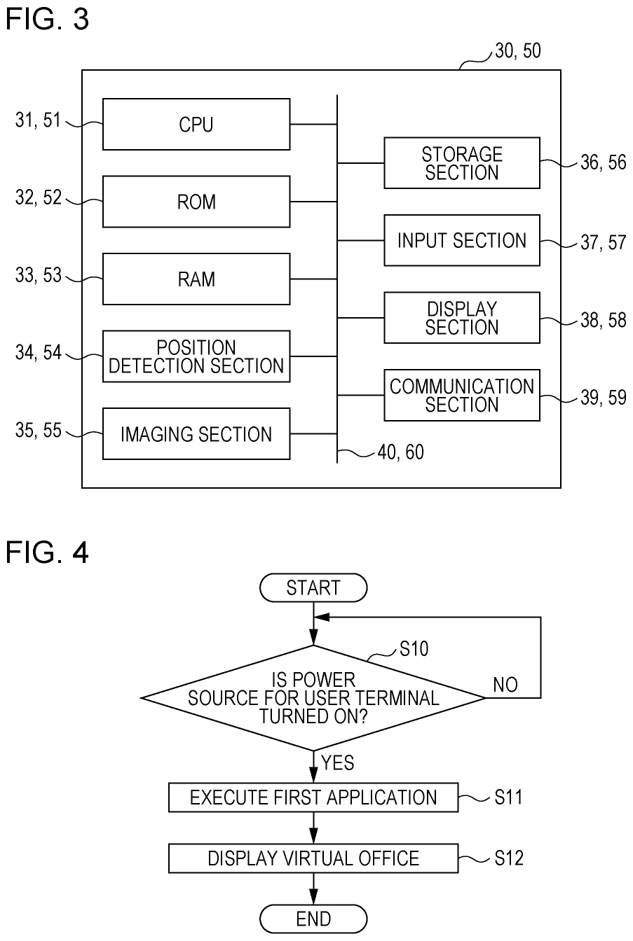

FIG. 3 is a block diagram illustrating the hardware configuration of the user terminal 30 and the user terminal 50. The user terminal 30 and the user terminal 50 may each be a general-purpose computer device such as a server computer and a personal computer, or a portable terminal such as a smartphone and a tablet terminal, by way of example. In the present exemplary embodiment, the user terminal 30 and the user terminal 50 are each a “smartphone”. The user terminal 30 and the user terminal 50 are each basically a common computer. Therefore, the user terminal 30 will be described as a representative.

As illustrated in FIG. 3, the user terminal 30 includes a CPU 31, a ROM 32, a RAM 33, a position detection section 34, an imaging section 35, a storage section 36, an input section 37, a display section 38, and a communication section 39. The various components are communicably connected to each other via a bus 40.

The CPU 31 is a central processing unit, and executes various programs and controls various sections. That is, the CPU 31 reads programs from the ROM 32 or the storage section 36, and executes the programs using the RAM 33 as a work area. The CPU 31 controls the various components described above and performs various computation processes in accordance with the programs stored in the ROM 32 or the storage section 36.

The ROM 32 stores various programs and various data. The RAM 33 serves as a work area to temporarily store the programs and the data.

The position detection section 34 detects the present location of the user terminal 30. By way of example, a signal from a Global Positioning System (GPS) satellite includes data on the time from an atomic clock mounted on the satellite, information on the orbit of the satellite, etc., and thus the position detection section 34 receives a radio wave from the GPS satellite and calculates the distance from the satellite on the basis of the time difference from the transmission to the reception. The position detection section 34 detects the present location of the user terminal 30 by measuring the position of a point in the space from the distances from three or more GPS satellites. The present location of the user terminal 30 detected by the position detection section 34 is transmitted to the information processing apparatus 20. The position detection section 34 may detect the present location of the user terminal 30 using Bluetooth (registered trademark), Wi-Fi (registered trademark), a beacon, etc. in addition to or instead of using the GPS.

The imaging section 35 is constituted of a camera that includes a solid-state imaging device such as a Charge Coupled Device (CCD) and a Complementary Metal Oxide Semiconductor (CMOS), by way of example. The imaging section 35 captures images at intervals determined in advance (e.g. every five minutes) during execution of a first application which is an application for displaying a virtual office. The images captured by the imaging section 35 are transmitted to the information processing apparatus 20.

The storage section 36 is constituted as a storage device such as an HDD, an SSD, and a flash memory, and stores various programs including an operating system and various data.

The input section 37 includes various buttons, a microphone, a camera, etc., for example, and is used to make various inputs.

The display section 38 may be a liquid crystal display, for example, and displays various types of information. The display section 38 adopts a touch screen to also function as the input section 37.

The communication section 39 is an interface for communication with a different device. The communication uses a standard for wired communication such as Ethernet (registered trademark) and Fiber-optic Data Distribution Interface (FDDI), or a standard for wireless communication such as 4G, 5G, and Wi-Fi (registered trademark), for example.

FIG. 4 is a flowchart illustrating the flow of a display process for displaying a virtual office on the user terminal 30 and the user terminal 50. The display process is performed by the information processing apparatus 20 when the CPU 21 reads the information processing program from the ROM 22 or the storage section 24, developing the information processing program in the RAM 23, and executing the information processing program.

In step S10 indicated in FIG. 4, the CPU 21 determines whether or not the power source for the user terminal 30 or the user terminal 50 is turned on. In the case where it is determined that the power source is turned on (step S10: YES), the process proceeds to step S11. In the case where the CPU 21 determines that the power source is not turned on (step S10: NO), on the other hand, the process stands by until the power source is turned on.

In step S11, the CPU 21 causes the user terminal which has been turned on to execute the first application. Then, the process proceeds to step S12. It is assumed as a precondition that the first application has been introduced in advance to the user terminal 30 and the user terminal 50. That is, the information processing apparatus 20 causes the user terminal which has been turned on to execute the first application by remotely operating the user terminal, without the user of the user terminal operating the user terminal.

In step S12, the CPU 21 causes the user terminal which has been turned on to display a virtual office. Then, the process is ended.

Next, a display example on the user terminal 30 and the user terminal 50 will be described using the user terminal 30 as a representative. It is assumed that the user terminal 30 is a terminal of a user B that works in the office building in which the workplace is located. That is, it is assumed that the following display example is displayed on the display section 38 of the user terminal 30 of the user B.

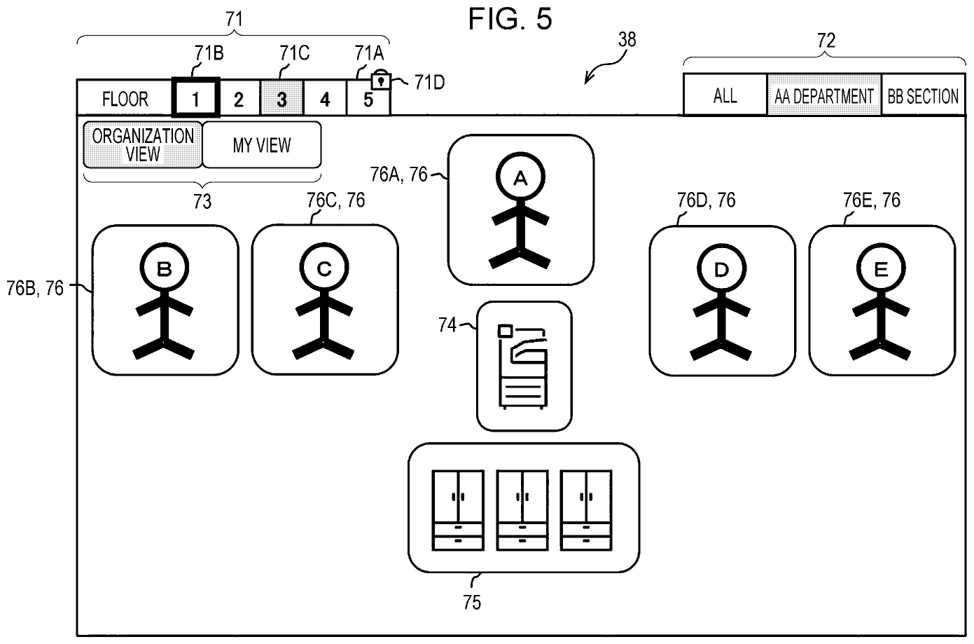

FIG. 5 illustrates a first display example of the virtual office. The CPU 21 causes the display section 38 of the user terminal 30 to display the virtual office illustrated in FIG. 5 when the first application is executed. In the virtual office, an image related to the user (hereinafter referred to as a “user image”) captured by the imaging section of the user terminal of the user who uses the virtual office or prepared in advance is displayed in a display range 76, to be discussed later, specified for each user. The “user image prepared in advance” includes an image stored in the user terminal of each user and an image prepared in advance on the side of the information processing apparatus 20 in order to provide the virtual office.

In the virtual office illustrated in FIG. 5, a floor display section 71, a group display section 72, a view switching section 73, a virtual image formation device 74, a virtual cabinet 75, and display ranges 76 are displayed.

The floor display section 71 displays floors of the virtual office. The floors are an example of the “regions”.

The floor display section 71 illustrated in FIG. 5 indicates that the virtual office has five floors of 1F to 5F. In the present exemplary embodiment, the floors of the virtual office correspond to the floors of the office building in which the workplace of the users who use the virtual office is located. That is, in the present exemplary embodiment, the office building has five floors of 1F to 5F, as with the floors of the virtual office.

In the present exemplary embodiment, the floor indicated by a numeral surrounded by a rectangular black frame in the floor display section 71 indicates the present floor of the virtual office. That is, the floor display section 71 illustrated in FIG. 5 indicates that the present floor of the virtual office is 1F.

The floors include an authentication floor 71A that accepts movement of a user from a different floor when the user succeeds in authentication determined in advance, an open floor 71B that accepts movement of a user from a different floor without succeeding in authentication, and a non-permissive floor 71C that does not accept movement of a user from a different floor. In the following, the authentication floor 71A and the open floor 71B will occasionally be referred to collectively as a “permissive floor”. The permissive floor is an example of the “permissive region”. The authentication floor 71A is an example of the “authentication region”. The open floor 71B is an example of the “open region”. The non-permissive floor 71C is an example of the “non-permissive region”.

In the present exemplary embodiment, by way of example, the authentication is “password authentication”. In the present exemplary embodiment, in addition, a floor indicated in the floor display section 71 by a numeral with white background and with a key mark 71D displayed at the upper right of a rectangular frame in which the numeral is displayed is defined as the “authentication floor 71A”, a floor indicated by a numeral with white background and with no key mark 71D displayed is defined as the “open floor 71B”, and a floor indicated by a numeral with background in a specific color (e.g. gray color) other than white is defined as the “non-permissive floor 71C”. In the present exemplary embodiment, as described above, the authentication floor 71A, the open floor 71B, and the non-permissive floor 71C are displayed in different display modes in the virtual office.

As discussed in detail later, movement between floors in the virtual office is made by performing an operation in a frame for a floor that is different from the present floor in the floor display section 71.

The group display section 72 displays user groups in the virtual office. The group display section 72 illustrated in FIG. 5 indicates that 1F of the virtual office is correlated with three groups, namely “all”, “AA department”, and “BB section”. In the present exemplary embodiment, the user groups correlated with each floor of the virtual office correspond to the user groups correlated with each floor of the office building in which the workplace of the users who use the virtual office is located. That is, in the present exemplary embodiment, the user groups for 1F of the office building include “AA department” and “BB section”, as with the virtual office.

In the present exemplary embodiment, a user group indicated by characters with background in a specific color in the group display section 72 indicates the user group presently displayed in the virtual office. That is, the group display section 72 illustrated in FIG. 5 indicates that the user group presently displayed in the virtual office is “AA department”.

As discussed in detail later, switching between user groups in the virtual office is made by performing an operation in a frame for a user group that is different from the user group presently displayed in the group display section 72.

The view switching section 73 is used to switch the view of the virtual office. The “view” is the display mode of the virtual office. The user images displayed in the virtual office are varied by switching the view.

In the present exemplary embodiment, the views include an organization view in which user images of users that constitute user groups correlated with a floor are displayed, and a MY view in which user images of a plurality of users are displayed irrespective of the floor. The views will be discussed in detail later. In the present exemplary embodiment, in addition, the view indicated by characters with background in a specific color in the view switching section 73 indicates the present view of the virtual office. That is, the view switching section 73 illustrated in FIG. 5 indicates that the present view of the virtual office is the “organization view”. The organization view is an example of the “first mode”. The MY view is an example of the “second mode”.

As discussed in detail later, switching between views in the virtual office is made by performing an operation in a frame for a view that is different from the present view in the view switching section 73.

The virtual image formation device 74 provides the functions of an image forming apparatus in the virtual office. When the virtual image formation device 74 is selected, a function screen (not illustrated) is displayed. Then, in the virtual office, a function selected on the function screen is executed.

In the present exemplary embodiment, the above functions include a first function of providing the function of an image forming apparatus without using the image forming apparatus installed in the office building in which the workplace of the users who use the virtual office is located, and a second function of providing the function of an image forming apparatus through cooperation of the virtual office and the image forming apparatus installed in the office building. By way of example, the first function allows facsimile transmission via the network N, and the second function allows transmission of an image captured by the imaging section of the user terminal to the image forming apparatus installed in the office building via the network N and copying, scanning, or facsimile transmission of the image received by the image forming apparatus.

The virtual cabinet 75 provides the function of a cabinet in the virtual office. When an icon displayed in a generally rectangular frame of the virtual cabinet 75 is selected, an information storage screen (not illustrated) of a cloud storage determined in advance is displayed. Then, in the virtual office, information may be stored in the cloud storage from the storage screen.

The display ranges 76 are each a generally rectangular frame which is specified for each user and in which a user image is displayed. In the virtual office illustrated in FIG. 5, user images of a plurality of users (users A to E) that constitute the user group “AA department” in the organization view for 1F are displayed in display ranges 76A to 76E, respectively, specified for the users. In FIG. 5, it is assumed that one or more of the users A to E work in the office building in which the workplace of the users is located while one or more users work at telework sites.

In the virtual office illustrated in FIG. 5, in addition, user images of all the users (users A to E) that constitute the user group “AA department” in the organization view for 1F are displayed. In the case where the user group presently displayed in the virtual office is “all” etc. and all the users that constitute the user groups may not be displayed on one screen, meanwhile, user images of other users are displayed by performing a switching operation to switch the user images. In the present exemplary embodiment, the switching operation is a scroll operation to scroll the screen, by way of example.

By way of example, photographs captured by the imaging section of the user terminal of each user are displayed in the display ranges 76A, 76B, 76C, 76D, and 76E as user images of the users A, B, C, D, and E, respectively, who are at their desks.

In the present exemplary embodiment, as described above, the user groups correlated with each floor of the virtual office correspond to the user groups correlated with each floor of the office building in which the workplace of the users who use the virtual office is located. Consequently, the users A to E who constitute the user group “AA department” have their desks on 1F in both the virtual office and the office building.

In addition, the virtual office is provided with a chat function.

In the virtual office, further, photographs captured by the imaging section of the user terminal of each user are displayed in the display ranges 76, which allows confirmation of collaborative work by the plurality of users.

In the case where a user moves between floors in the virtual office, the CPU 21 performs a movement process of displaying user images of users that constitute user groups correlated with the floor as the movement destination in the display ranges 76 specified for the users, respectively, and displaying a user image of the user who has moved in the display range 76 for the user who has moved. The movement process will be described in detail below.

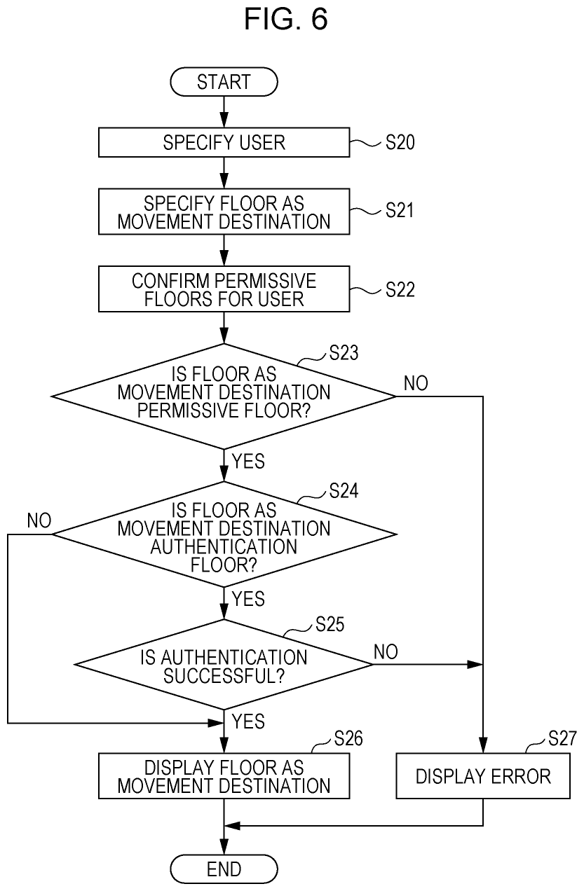

FIG. 6 is a flowchart illustrating the flow of the movement process. The movement process is performed by the information processing apparatus 20 when the CPU 21 reads the information processing program from the ROM 22 or the storage section 24, developing the information processing program in the RAM 23, and executing the information processing program.

In step S20 indicated in FIG. 6, the CPU 21 specifies a user that desires to move between floors. Then, the process proceeds to step S21.

In step S21, the CPU 21 specifies a floor as the movement destination. Then, the process proceeds to step S22.

In step S22, the CPU 21 confirms permissive floors for the user who desires to move between floors. Then, the process proceeds to step S23.

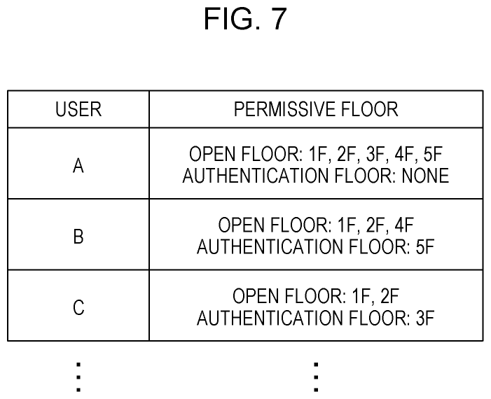

The storage section 24 stores a permissive floor table that indicates setting of permissive floors for each user. FIG. 7 illustrates an example of the permissive floor table.

As indicated in FIG. 7, the permissive floor table indicates “permissive floors” in which “open floors” and “authentication floors” are defined for each user. By way of example, the permissive floor table indicated in FIG. 7 indicates permissive floors for the users A, B, and C. The permissive floors for the user A include open floors “1F to 5F” and “no” authentication floors. The permissive floors for the user B include open floors “1F, 2F, and 4F” and an authentication floor “5F”. The permissive floors for the user C include open floors “1F and 2F” and an authentication floor “3F”.

Returning to FIG. 6, in step S23, the CPU 21 references the permissive floor table, and determines whether or not the floor as the movement destination is a permissive floor. In the case where the CPU 21 determines that the floor as the movement destination is a permissive floor (step S23: YES), the process proceeds to step S24. In the case where the CPU 21 determines that the floor as the movement destination is not a permissive floor (step S23: NO), on the other hand, the process proceeds to step S27.

In step S24, the CPU 21 references the permissive floor table, and determines whether or not the floor as the movement destination is an authentication floor. In the case where the CPU 21 determines that the floor as the movement destination is an authentication floor (step S24: YES), the process proceeds to step S25. In the case where the CPU 21 determines that the floor as the movement destination is not an authentication floor, that is, the floor as the movement destination is an open floor (step S24: NO), on the other hand, the process proceeds to step S26.

In step S25, the CPU 21 determines whether or not authentication is successful. In the case where the CPU 21 determines that authentication is successful (step S25: YES), the process proceeds to step S26. In the case where the CPU 21 determines that authentication is not successful (step S25: NO), on the other hand, the process proceeds to step S27.

In step S26, the CPU 21 displays the floor as the movement destination. Then, the process is ended.

In step S27, the CPU 21 displays an error indicating that the user is not able to move to the desired floor. Then, the process is ended.

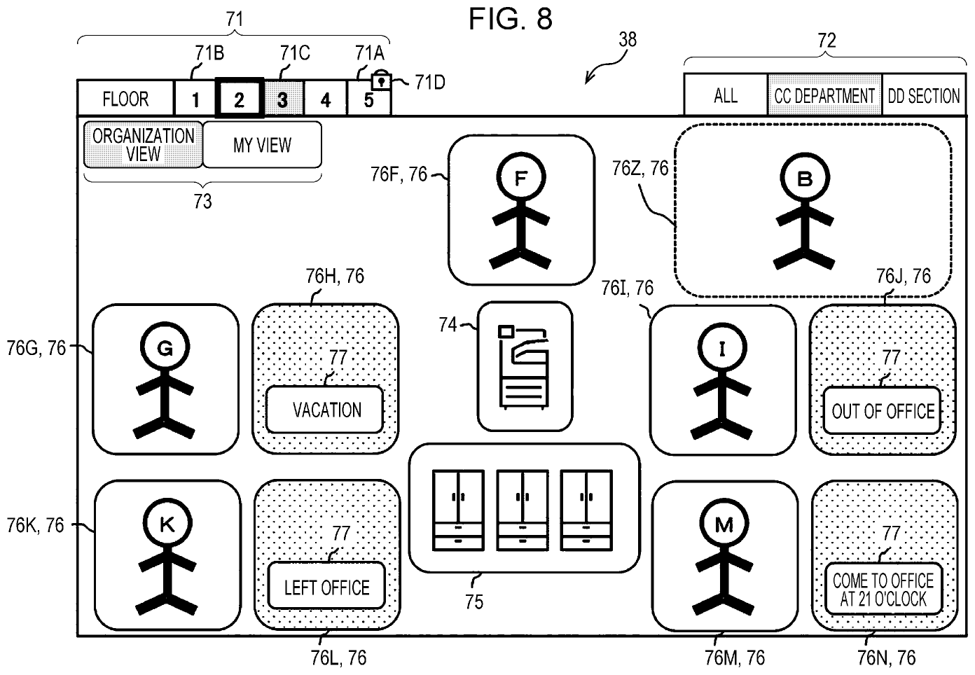

FIG. 8 illustrates a second display example of the virtual office. In the display example illustrated in FIG. 8, the present floor in the virtual office has been switched from that in the display example illustrated in FIG. 5.

In the virtual office illustrated in FIG. 8, as in the virtual office illustrated in FIG. 5, a floor display section 71, a group display section 72, a view switching section 73, a virtual image formation device 74, a virtual cabinet 75, and display ranges 76 are displayed.

In the floor display section 71 illustrated in FIG. 8, numeral “2” is surrounded by a rectangular black frame to indicate that the present floor of the virtual office is 2F.

The group display section 72 illustrated in FIG. 8 indicates that 2F of the virtual office is correlated with three groups, namely “all”, “CC department”, and “DD section”. In addition, the group display section 72 illustrated in FIG. 8, in which characters “CC department” have background displayed in a specific color, indicates that the user group presently displayed in the virtual office is “CC department”. In the present exemplary embodiment, the user groups for 2F of the office building in which the workplace of the users who use the virtual office is located include “CC department” and “DD section”, as with the virtual office.

In the virtual office illustrated in FIG. 8, user images of a plurality of users (users F to N) that constitute the user group “CC department” in the organization view for 2F are displayed in display ranges 76F to 76N, respectively, specified for the users. In FIG. 8, it is assumed that the users F, G, I, K, and M are at their desks, and that the users H, J, L, and N are away from their desks. In FIG. 8, in addition, it is assumed that one or more of the users F to N work in the office building in which the workplace of the users is located while one or more users work at telework sites. In the present exemplary embodiment, the users F to N who constitute the user group “CC department” have their desks on 2F in both the virtual office and the office building.

By way of example, photographs captured by the imaging section of the user terminal of each user are displayed in the display ranges 76F, 76G, 76I, 76K, and 76M as user images of the users F, G, I, K, and M, respectively, who are at their desks.

In addition, by way of example, dot background images prepared in advance on the side of the information processing apparatus 20 in order to provide the virtual office are displayed in the display ranges 76H, 76J, 76L, and 76N as user images of the users H, J, L, and N, respectively, who are away from their desks.

In the present exemplary embodiment, as described above, the CPU 21 displays the display ranges 76 in different display modes in the virtual office in accordance with whether the users are at or away from their desks.

In the present exemplary embodiment, in the case where a user has moved between floors in the virtual office, the CPU 21 displays user images of users that constitute the user group “CC department” on 2F in the display ranges 76F to 76N, and displays a user image of the user who has moved in the display range 76 for the user who has moved, as described above. In FIG. 8, the user who has moved from a different floor is defined as a “user B”.

The CPU 21 displays a user image of the user B who has moved from 1F to 2F in a display range 76Z which is the display range 76 for the user who has moved. The display range 76Z is a generally rectangular frame indicated by the broken line and displayed below the group display section 72 in the case where there is a user who has moved from a different floor to display a user image of the user who has moved.

In recent years, the way of working for a company has been diversified, and telework which allows people to work at places other than an office building in which their workplace is located, such as their personal residences, has been introduced in addition to a work system that requires people to work on site in the office building. Along with this trend, groupware such as Web conference systems has been spread in recent years as tools for communication among employees that work at a plurality of locations.

When an employee actually works on site in an office building in which office spaces are present on a plurality of floors, a certain user may move from a floor that the user is presently on to a different floor to communicate with users that are on the destination floor. There are also users that are not the communication target on the destination floor, and the user who has moved from a different floor may grasp information such as the work status of such users.

However, the current groupware is capable of displaying only users invited to a group on a screen, and therefore allows users to grasp limited information on the types of users compared to the case where the users work on site in the office building.

Thus, in the present exemplary embodiment, the CPU 21 correlates user groups constituted from users that are present at a plurality of locations in the real space with floors of a virtual office between which the users are movable. In the case where a user has moved between floors in the virtual office, the CPU 21 displays user images of users that constitute user groups correlated with the floor as the movement destination in the display ranges 76 specified for the users, and displays a user image of the user who has moved in the display range 76Z for the user who has moved (see FIG. 8).

In the present exemplary embodiment, the floors in the virtual office include permissive floors that accept movement of a user from a different floor, and non-permissive floors 71C that do not accept movement of a user from a different floor. The CPU 21 receives setting of permissive floors for each user.

In the present exemplary embodiment, the permissive floors in the virtual office include authentication floors 71A that accept movement of a user from a different floor when the user succeeds in authentication determined in advance, and open floors 71B that accept movement of a user from a different floor without succeeding in authentication.

In the present exemplary embodiment, the CPU 21 displays the open floor 71B, the authentication floor 71A, and the non-permissive floor 71C in different display modes in the virtual office.

In the present exemplary embodiment, the CPU 21 displays schedules of users input to a scheduler that manages the schedules of the users in the display ranges 76 specified for the users in the virtual office. Specifically, in the present exemplary embodiment, when a schedule of a user input to the scheduler is a schedule of absence which indicates that the user is scheduled to be absent, the CPU 21 displays the schedule of absence in the display range 76 specified for the user in the virtual office. The “schedule of absence” indicates that the user is away from his/her desk and absent. Examples of the schedule of absence include “Left office”, “Vacation”, “Out of office”, and “Come to office at XX o'clock”. In FIG. 8, the users H, J, L, and N who are away from their desks have input their schedules of absence to the scheduler in advance.

As illustrated in FIG. 8, a schedule display section 77 that displays a schedule of a user is provided in the display ranges 76H, 76J, 76L, and 76N. In FIG. 8, the schedule display section 77 in the display range 76H displays “Vacation”, the schedule display section 77 in the display range 76J displays “Out of office”, the schedule display section 77 in the display range 76L displays “Left office”, and the schedule display section 77 in the display range 76N displays “Come to office at 21 o'clock, as the schedule of absence.

In the present exemplary embodiment, when an on-site user who works on site in the office building in which the workplace of the user who uses the virtual office is located is away from his/her desk, the CPU 21 displays position information on the on-site user in the office building in the display range 76 for the on-site user in the virtual office.

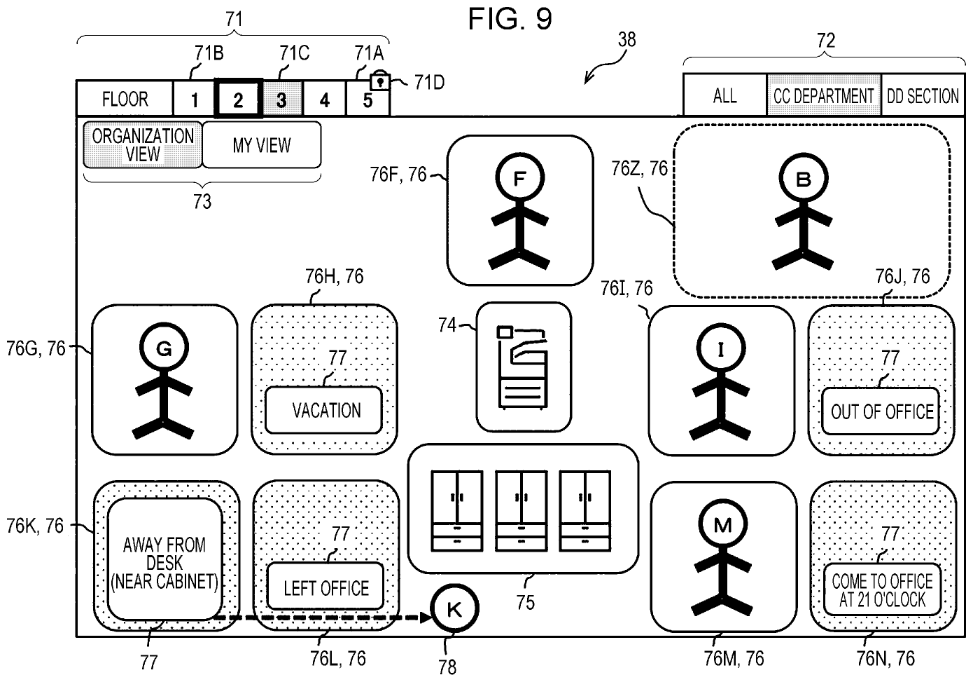

FIG. 9 illustrates a third display example of the virtual office. In the display example illustrated in FIG. 9, the display mode of the display range 76K has been varied from that in the display example illustrated in FIG. 8. It is assumed that the user K is working on site in the office building in which the workplace is located, and corresponds to the on-site user described above.

The CPU 21 acquires a present location detected by the position detection section of the user terminal of the user K, and displays “Away from desk (near cabinet)” in the schedule display section 77 in the display range 76K, as illustrated in FIG. 9, when the acquired present location is near a cabinet installed in the office building in which the workplace is located. In this case, further, the CPU 21 displays a position indication 78, which indicates position information on the user K in the office building, below the virtual cabinet 75.

In the present exemplary embodiment, when the action of a user indicated by a user image displayed in the virtual office is different from the schedule of the user input to the scheduler, the CPU 21 displays error information indicating that the action of the user and the schedule do not agree with each other in the display range 76 specified for the user in the virtual office.

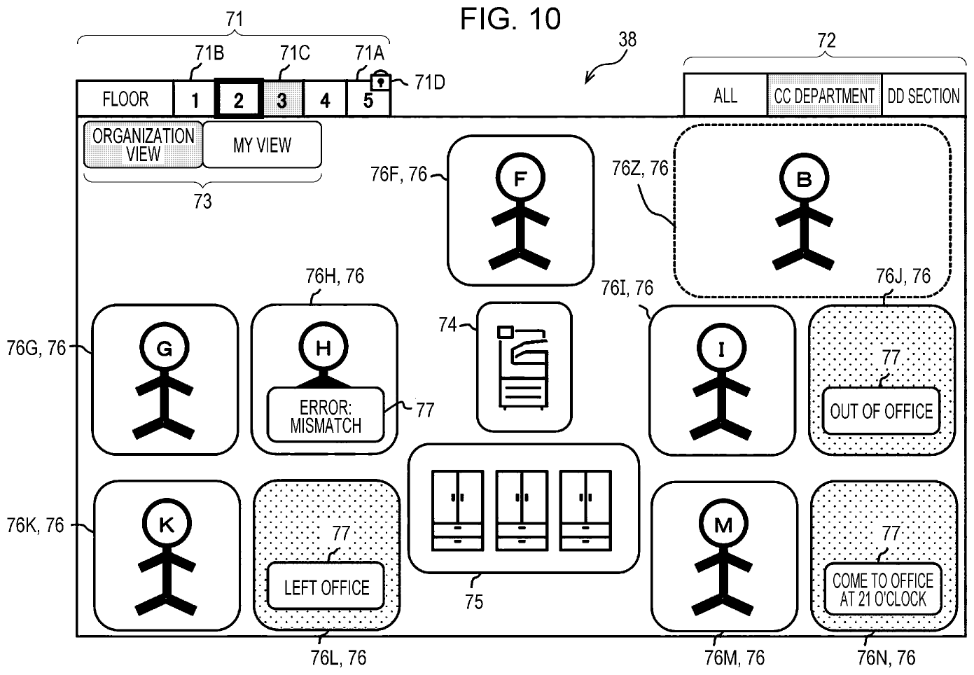

FIG. 10 illustrates a fourth display example of the virtual office. In the display example illustrated in FIG. 10, the display mode of the display range 76H has been varied from that in the display example illustrated in FIG. 8. In FIG. 10, it is assumed that the user H has input “Vacation” to the scheduler as the schedule of absence in advance.

A photograph captured by the imaging section of the user terminal of the user H is displayed in the display range 76H illustrated in FIG. 10, in place of the dot background image displayed as the user image of the user H in the display range 76H illustrated in FIG. 8. At this time, the schedule and the action do not agree with each other if the photograph of the user H captured by the imaging section is displayed in the display range H, since the schedule of the user H input to the scheduler is “Vacation”. Therefore, in FIG. 10, the CPU 21 displays “Error: mismatch” as error information in the schedule display section 77 in the display range 76H.

In the above example in which the action and the schedule of a user do not agree with each other, a photograph of the user is displayed in the display range 76 when the schedule is “Vacation”. However, an example in which the action and the schedule of a user do not agree with each other is not limited thereto. In a different “example in which the action and the schedule of a user do not agree with each other”, a photograph of the user may not be displayed in the display range 76 for a period determined in advance or more when the schedule is “On site”.

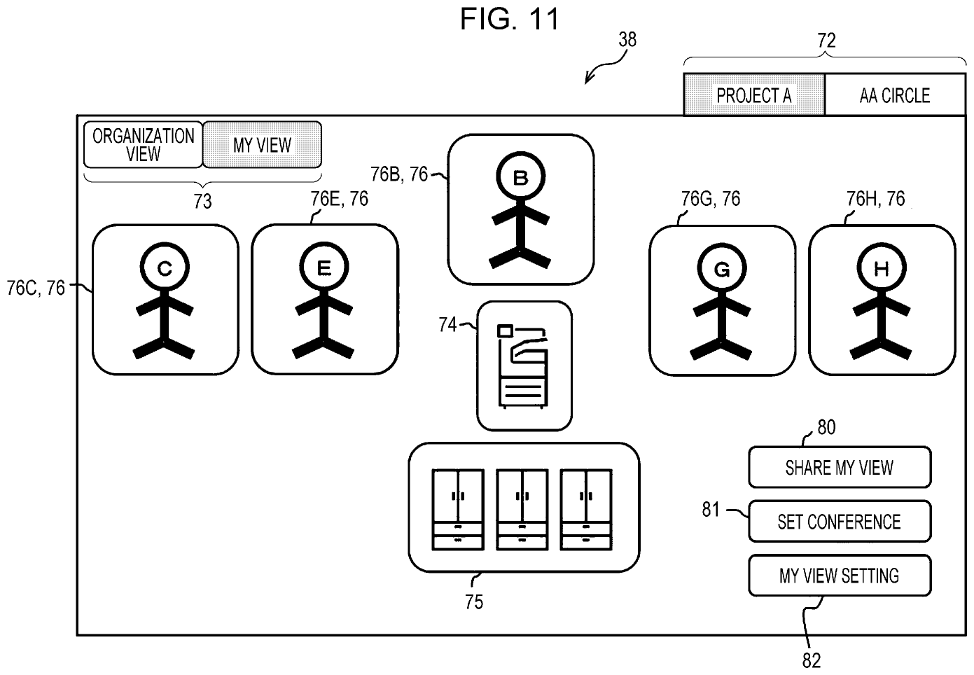

FIG. 11 illustrates a fifth display example of the virtual office.

In the virtual office illustrated in FIG. 11, a group display section 72, a view switching section 73, a virtual image formation device 74, a virtual cabinet 75, display ranges 76, a MY view sharing button 80, a conference setting button 81, and a MY view setting button 82 are displayed.

The group display section 72 illustrated in FIG. 11 indicates that two groups “project A” and “AA circle” are correlated with MY view of the user B. The group display section 72 illustrated in FIG. 11, in which characters “project A” have background displayed in a specific color, indicates that the user group presently displayed in the virtual office is “project A”.

The view switching section 73 illustrated in FIG. 11, in which characters “MY view” have background displayed in a specific color, indicates that the present view of the virtual office is “MY view”.

The virtual cabinet 75 illustrated in FIG. 11 provides the function of a cabinet exclusively for MY view of the user B. Therefore, when an icon displayed in a frame of the virtual cabinet 75 illustrated in FIG. 11 is selected, an information storage screen (not illustrated) of a cloud storage exclusively for MY view of the user B is displayed.

In the virtual office illustrated in FIG. 11, user images of a plurality of users (users B, C, E, G, and H) that constitute the user group “project A” in MY view are displayed in display ranges 76B, 76C, 76E, 76G, and 76H, respectively, specified for the users. In this manner, in MY view, a single user group is constituted from the “users B, C, and E” who are correlated with the user group “AA department” on 1F and the “users G and H” who are correlated with the user group “CC department” on 2F, irrespective of the floor.

The MY view sharing button 80 is a button for generating a user group in MY view. When the MY view sharing button 80 is selected, an invitation screen (not illustrated) that invites users that constitute a user group to be generated is displayed. Then, in the virtual office, an invitation notification is transmitted to the user terminals of the users who are invited on the invitation screen, and the invited users become constituent members of the user group to which the users are invited upon accepting the invitation notification.

The conference setting button 81 is a button for setting a schedule of a Web conference in schedulers of a plurality of users that constitute a user group in MY view. When the conference setting button 81 is selected, an input screen (not illustrated) that allows input of the date and time of the Web conference is displayed. Then, in the virtual office, a schedule of the Web conference at the date and time input to the input screen is input to the schedulers of the plurality of users that constitute the user group in MY view.

The MY view setting button 82 is a button for adding or deleting a user that constitutes a generated user group. When the MY view setting button 82 is selected, a setting screen (not illustrated) for adding or deleting a user that constitutes a generated user group is displayed. Then, in the virtual office, an invitation notification is transmitted to the user terminal of the user who has been added on the setting screen, and the invited user becomes a constituent member of the generated user group upon accepting the invitation notification. In the virtual office, meanwhile, the user who has been deleted on the setting screen is excluded from the constituent members of the generated user group.

In the present exemplary embodiment, as described above, the views as the display modes of the virtual office include an organization view in which user images of users that constitute user groups correlated with a floor are displayed, and a MY view in which user images of a plurality of users are displayed irrespective of the floor. Therefore, with the present exemplary embodiment, user groups constituted from various combinations of users are provided compared to the configuration in which there is only one view of the virtual office.

In the present exemplary embodiment, in the case where a user has moved between floors in the virtual office, the CPU 21 displays a user image of a special user in the display range 76 for the special user on the floor as the movement destination when the special user is included in users that constitute a user group correlated with the floor as the movement destination.

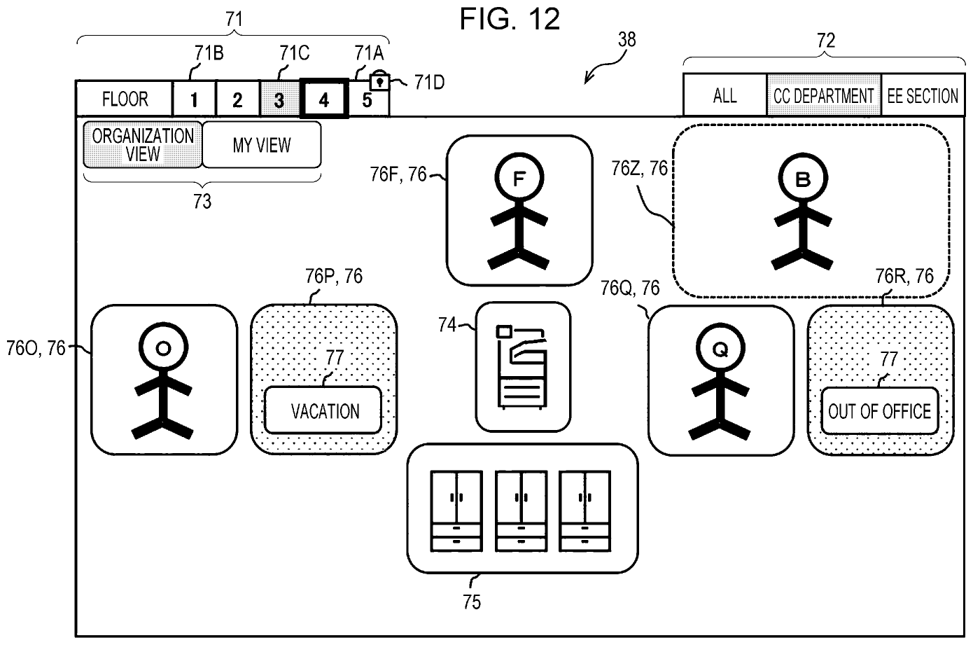

FIG. 12 illustrates a sixth display example of the virtual office. In the display example illustrated in FIG. 12, the present floor in the virtual office has been switched from that in the display example illustrated in FIG. 8.

In the virtual office illustrated in FIG. 12, as in the virtual office illustrated in FIG. 8, a floor display section 71, a group display section 72, a view switching section 73, a virtual image formation device 74, a virtual cabinet 75, and display ranges 76 are displayed.

In the floor display section 71 illustrated in FIG. 12, numeral “4” is surrounded by a rectangular black frame to indicate that the present floor of the virtual office is 4F.

The group display section 72 illustrated in FIG. 12 indicates that 4F of the virtual office is correlated with three groups, namely “all”, “CC department”, and “EE section”. In addition, the group display section 72 illustrated in FIG. 12, in which characters “CC department” have background displayed in a specific color, indicates that the user group presently displayed in the virtual office is “CC department”. In the present exemplary embodiment, the user groups for 4F of the office building in which the workplace of the users who use the virtual office is located include “CC department” and “EE section”, as with the virtual office.

In the virtual office illustrated in FIG. 12, user images of a plurality of users (users F and O to R) that constitute the user group “CC department” in the organization view for 4F are displayed in display ranges 76F and 760 to 76N, respectively, specified for the users. In FIG. 12, it is assumed that the users F, O, and Q are at their desks, and that the users P and R are away from their desks. In FIG. 12, in addition, it is assumed that one or more of the users F and 0 to R work in the office building in which the workplace of the users is located while one or more users work at telework sites. In the present exemplary embodiment, the users F and O to R who constitute the user group “CC department” have their desks on 4F in both the virtual office and the office building.

By way of example, photographs captured by the imaging section of the user terminal of each user are displayed in the display ranges 76F, 760, and 76Q as user images of the users F, O, and Q, respectively, who are at their desks.

In addition, by way of example, dot background images prepared in advance on the side of the information processing apparatus 20 in order to provide the virtual office are displayed in the display ranges 76P and 76R as user images of the users P and R, respectively, who are away from their desks.

In the virtual office illustrated in FIG. 12, a user image of the user B who has moved from 2F to 4F is displayed in the display range 76Z for the user who has moved.

In the virtual office, the user group “CC department” is correlated with two floors, namely 2F and 4F (see FIGS. 8 and 12). At this time, it is assumed that the user F is the department head of the user group “CC department”, and that setting is made to display a user image of the department head at the upper portion of the virtual image formation device 74, in the case where the user group “CC department” is displayed in the virtual office. Therefore, in the virtual office, the user image of the user F who is the department head of the user group “CC department” is displayed on both the floor as the movement origin and the floor as the movement destination, even in the case where the user B has moved from 2F to 4F. That is, in this case, the user F corresponds to the “special user” described above.

The CPU 21 displays the virtual office along with display performed using a second application that is different from the first application for displaying the virtual office, even in the case where the second application is executed to perform display using the second application. In the present exemplary embodiment, the second application is an application for displaying an electronic book which is a book recorded electromagnetically.

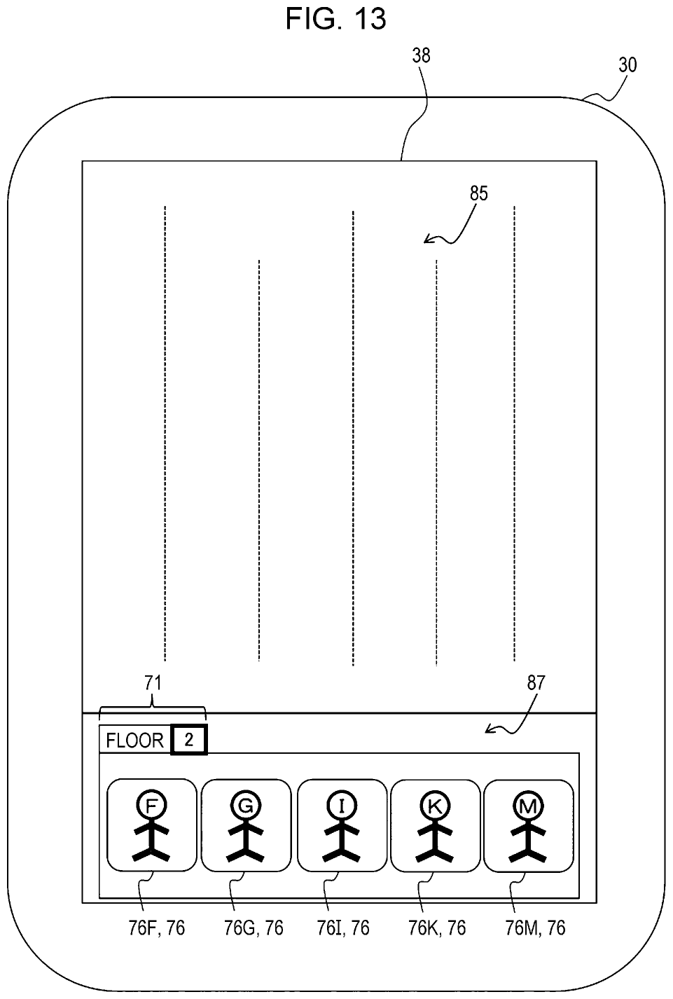

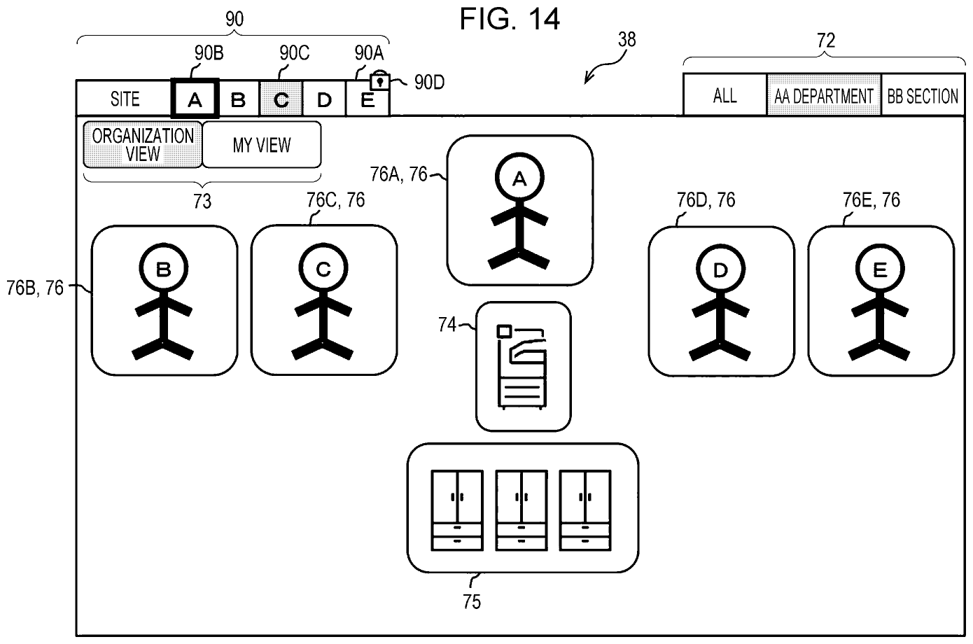

FIG. 13 illustrates an example of display on the user terminal 30. The CPU 21 causes the display section 38 of the user terminal 30 to display the virtual office illustrated in FIG. 13 when the second application is executed to display an electronic book as display performed by the second application. Specifically, FIG. 13 illustrates a state after the second application is executed during display of the virtual office illustrated in FIG. 8.

In FIG. 13, the display region of the display section 38 is divided into a first region 85 for displaying the electronic book and a second region 87 for displaying the virtual office. The CPU 21 displays the virtual office in the second region 87.

The floor display section 71 and the display ranges 76 are displayed in the virtual office illustrated in FIG. 13.

Only the present floor of the virtual office is displayed in the floor display section 71 illustrated in FIG. 13. That is, the floor display section 71 illustrated in FIG. 13 only indicates that the present floor of the virtual office is 2F.

Only user images of users viewing the display example illustrated in FIG. 13, specifically users that are at their desks excluding the user B, are displayed in the display ranges 76 illustrated in FIG. 13. Therefore, in the display ranges 76 illustrated in FIG. 13, the user images of the users F, G, I, K, and M who are at their desks, among a plurality of users (users F to N) that constitute the user group “CC department” on 2F of the virtual office, are displayed in the display ranges 76F, 76G, 76I, 76K, and 76M, respectively.

In FIG. 13, the display area of the first region 85 is larger than the display area of the second region 87. However, the present disclosure is not limited thereto. The display area of the second region 87 may be larger than the display area of the first region 85. The display region of the display section 38 may not be divided into the first region 85 and the second region 87 as described above, and the virtual office may be displayed on the front side of the electronic book as superposed on the display region in which the electronic book is displayed.

(Others)

In the exemplary embodiment described above, the floors are an example of the “regions”. However, the “regions” may be any units determined in advance, and are not limited to the floors. In another example, the “regions” may be units provided at a plurality of locations in the real space, such as “sites” and “business offices”.

FIG. 14 illustrates a seventh display example of the virtual office. A site display section 90 which displays sites of the virtual office as an example of the “regions” is displayed in the virtual office illustrated in FIG. 14, in place of the floor display section 71 of the virtual office in the exemplary embodiment described above.

The site display section 90 illustrated in FIG. 14 indicates that the virtual office has five sites of A to E. In the site display section 90, the letter “A” is surrounded by a rectangular black frame to indicate that the present site of the virtual office is A. In this case, the sites of the virtual office may correspond to, or may be different from, the sites of the workplace of the users who use the virtual office. That is, in this case, the workplace may have five sites of A to E as with the sites of the virtual office, or may have more or less than five sites.

The sites include an authentication site 90A that is marked with a lock mark 90D and that accepts movement of a user from a different site when the user succeeds in authentication determined in advance, an open site 90B that accepts movement of a user from a different site without succeeding in authentication, and a non-permissive site 90C that does not accept movement of a user from a different site. The authentication site 90A and the open site 90B are collectively referred to as a “permissive site”. The permissive site is an example of the “permissive region”. The authentication site 90A is an example of the “authentication region”. The open site 90B is an example of the “open region”. The non-permissive site 90C is an example of the “non-permissive region”.

In the exemplary embodiment described above, a schedule of absence is displayed in the display range 76 only when the schedule of the user input to the scheduler is a schedule of absence. However, the present disclosure is not limited thereto. A schedule of a user during a period for which the user is at his/her desk may be displayed in the display range 76 specified for each user in the virtual office.

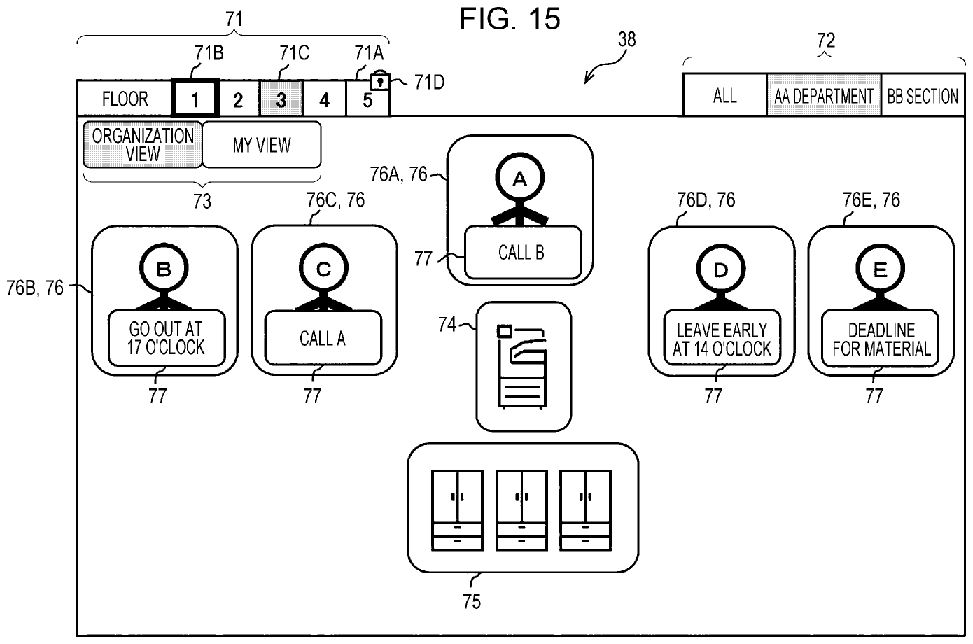

FIG. 15 illustrates an eighth display example of the virtual office. Examples of the schedule during a period for which the user is at his/her desk include “Call XX”, “Leave office early at XX o′clock”, “Go out at XX o′clock”, and “Deadline for XX”. In FIG. 15, it is assumed that the users A to E who are at their desks have input their schedules during a period for which the users A to E are at their desks to the scheduler in advance. In FIG. 15, the schedule display section 77 in the display range 76A displays “Call B”, the schedule display section 77 in the display range 76B displays “Go out at 17 o'clock”, the schedule display section 77 in the display range 76C displays “Call A”, the schedule display section 77 in the display range 76D displays “Leave office early at 14 o′clock”, and the schedule display section 77 in the display range 76E displays “Deadline for material”, as the schedule during a period for which the users are at their desks.

In the exemplary embodiment described above, the imaging section of the user terminal captures images at intervals determined in advance (e.g. every five minutes) during execution of the first application. However, the capture timings are not limited thereto. Images may be captured in real time. In addition, the CPU of the user terminal may monitor a load on the network N, and switch between capturing images at intervals determined in advance and capturing images in real time.

In the exemplary embodiment described above, images are captured using the imaging section provided in the user terminal. However, the present disclosure is not limited thereto. Images may be captured using an imaging section provided in a device that is different from the user terminal. Consequently, the user image captured by the imaging section is not limited to a photograph of the user, and may be a different image such as a photograph of the display section of the user terminal.

In the exemplary embodiment described above, the authentication determined in advance is password authentication. However, the present disclosure is not limited thereto. The “authentication determined in advance” may be possession authentication, biometric authentication, etc. In addition, “two-factor authentication” or “two-step authentication” may be used to determine whether or not the authentication determined in advance is made successfully.

In the exemplary embodiment described above, the virtual office does not include a sound input/output function. However, the present disclosure is not limited thereto. The virtual office may include a sound input/output function. In the case where the virtual office includes a sound input/output function, input of only some of sounds may be received such as when a user is spoken to by a user displayed in a display range 76 that is adjacent on one of the upper, lower, left, and right sides.

In the exemplary embodiment described above, the user terminal 30 is assumed as a “smartphone”, and a display example of the virtual office on the “smartphone” is described. In this event, the amount of information on the virtual office to be displayed on one screen may be varied in accordance with the display environment which may differ depending on the terminal which displays the virtual office etc. In the case where the user terminal 30 is a “personal computer”, by way of example, the number of display ranges 76 that may be displayed on one screen may be increased compared to the case where the user terminal 30 is a “smartphone”.

In the exemplary embodiment described above, the floor display section 71, the group display section 72, the view switching section 73, the virtual image formation device 74, the virtual cabinet 75, and the display ranges 76 are displayed as the virtual office on one screen of the user terminal 30 (see FIG. 5). In this event, information to be displayed as the virtual office on one screen of the user terminal 30 may be set in advance on the side of the information processing apparatus 20, or desired information may be selected and displayed on the side of the user terminal 30. In the case where setting is made so as to select and display desired information on the side of the user terminal 30, by way of example, it is possible to display only the floor display section 71, display only the virtual image formation device 74 and the virtual cabinet 75, display only the display range 76 for a user, whose frequency of interaction per unit time exceeds a threshold determined in advance, or display only the display range 76 for a user that is at his/her desk.

In the exemplary embodiment described above, a user that is the department head is determined as an example of the “special user”, and a user image of such a user is displayed on both the floor as the movement origin and the floor as the movement destination when a user has moved between floors in the virtual office. However, the department head is not the only example of the “special user”. An approver of work may be an example of the “special user”, by way of example.

In the exemplary embodiment described above, position information, in the office building, on an on-site user that is working in the office building in which the workplace of the user is present is indicated by displaying the present location in the schedule display section 77 in the display range 76 for the on-site user. However, the manner of indicating the position information is not limited thereto. Position information on the on-site user in the office building may be indicated using only the position display 78, without displaying the present location in the schedule display section 77, by way of example. Alternatively, only the present floor may be indicated as the position display 78, without indicating the detailed position on the floor. In another example, the schedule display section 77 may display “Away from desk”, and display the present location when the schedule display section 77 is selected.

In the exemplary embodiment described above, the virtual office is constituted as a so-called “company's own building” which is occupied by only one workplace. However, the present disclosure is not limited thereto. The virtual office may be constituted as a so-called “multi-tenant building” which is occupied by a plurality of workplaces.

In the exemplary embodiment described above, the floors of the virtual office correspond to the floors of the office building in which the workplace of the users who use the virtual office is located. However, the present disclosure is not limited thereto. The floors of the virtual office may be different from the floors of the office building. The number of floors of the virtual office may be more or less than the number of floors of the office building, by way of example.

In the exemplary embodiment described above, the user groups correlated with each floor of the virtual office correspond to the user groups correlated with each floor of the office building in which the workplace of the users who use the virtual office is located. However, the present disclosure is not limited thereto. A user group correlated with 1F in the virtual office may be correlated with 2F in the office building, by way of example. In the case where the user groups correlated with each floor of the virtual office are different from the user groups correlated with each floor of the office building, users that constitute the user groups have their desks on different floors in the virtual office and the office building.

In the exemplary embodiment described above, the information processing apparatus 20 is a “server computer”. In this case, the information processing apparatus 20 may be constituted of one “server computer” or a plurality of “server computers”.

In the exemplary embodiment described above, a plurality of icons that indicate cabinets are displayed in the frame of the virtual cabinet 75 (see FIG. 5). In this case, cabinets corresponding to each user may be provided. By way of example, users displayed in the display ranges 76 positioned on the left side with respect to the virtual cabinet 75 in the virtual office may be able to select only an icon that indicates a cabinet on the left side in the virtual cabinet 75.

In the exemplary embodiment described above, when a user has moved between floors in the virtual office, a user group correlated with the floor as the movement destination is displayed in the group display section 72. At this time, the user group to be displayed may be varied in accordance with the authority of each user that has moved.

In the exemplary embodiment described above, a specific exemplary embodiment of the AR function is not described. In the case where a display section that includes the AR function is adopted, the virtual office may be displayed as superposed on an image of the real space captured by the imaging section. In this case, the virtual office may not be displayed in the case where specific position information or image information on the real space may not be acquired.

In the exemplary embodiment described above, a specific exemplary embodiment of the VR function is not described. In the case where a display section that includes the VR function is adopted, different images may be disposed in various directions of the viewing field. By way of example, floors may be displayed for each predetermined angle in the left direction, or a MY view or Web conference screen may be allocated to a predetermined angle in the right direction. Likewise, a plurality of display screens may be switchably displayed in the depth direction. To switch VR display, action for authentication may be requested to switch between images in conjunction with motion of the head portion etc. made along with a change in the direction of the viewing field.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
correlate user groups each constituted from users that are present at a plurality of locations in a real space with regions in a virtual space in which movement between the regions is allowed; and
display, when a user has moved between the regions in the virtual space, images related to users that constitute a user group correlated with a region as a movement destination in display ranges specified for the users, respectively, and display an image related to the user who has moved in a display range for the user who has moved.

2. The information processing apparatus according to claim 1,
wherein the regions include permissive regions that accept movement of a user from a different region, and non-permissive regions that do not accept movement of a user a different region, and
the processor is configured to receive setting of the permissive regions for each of the users.

3. The information processing apparatus according to claim 2,
wherein the permissive regions include authentication regions that accept movement from a different region of a user that has succeeded in authentication determined in advance, and open regions that accept movement of a user from a different region without requiring the user to succeed in the authentication.

4. The information processing apparatus according to claim 3,
wherein the processor is configured to make respective modes of display of the open regions, the authentication regions, and the non-permissive regions different from each other in the virtual space.

5. The information processing apparatus according to claim 1,
wherein the processor is configured to display schedules of the users input to a scheduler that manages the schedules of the users in the display ranges specified for the users, respectively, in the virtual space.

6. The information processing apparatus according to claim 2,
wherein the processor is configured to display schedules of the users input to a scheduler that manages the schedules of the users in the display ranges specified for the users, respectively, in the virtual space.

7. The information processing apparatus according to claim 3,
wherein the processor is configured to display schedules of the users input to a scheduler that manages the schedules of the users in the display ranges specified for the users, respectively, in the virtual space.

8. The information processing apparatus according to claim 4,
wherein the processor is configured to display schedules of the users input to a scheduler that manages the schedules of the users in the display ranges specified for the users, respectively, in the virtual space.

9. The information processing apparatus according to claim 5,
wherein the processor is configured to display, when a schedule of a user input to the scheduler is a schedule of absence which indicates that the user is scheduled to be absent, the schedule of absence in a display range specified for the user in the virtual space.

10. The information processing apparatus according to claim 6,
wherein the processor is configured to display, when a schedule of a user input to the scheduler is a schedule of absence which indicates that the user is scheduled to be absent, the schedule of absence in a display range specified for the user in the virtual space.

11. The information processing apparatus according to claim 7,
wherein the processor is configured to display, when a schedule of a user input to the scheduler is a schedule of absence which indicates that the user is scheduled to be absent, the schedule of absence in a display range specified for the user in the virtual space.

12. The information processing apparatus according to claim 8,
wherein the processor is configured to display, when a schedule of a user input to the scheduler is a schedule of absence which indicates that the user is scheduled to be absent, the schedule of absence in a display range specified for the user in the virtual space.

13. The information processing apparatus according to claim 5,
wherein the processor is configured to display, when an on-site user who works on site at a workplace at which the user works is away from his/her desk, displays position information on the on-site user at the workplace in a display range for the on-site user in the virtual space.

14. The information processing apparatus according to claim 6,
wherein the processor is configured to display, when an on-site user who works on site at a workplace at which the user works is away from his/her desk, displays position information on the on-site user at the workplace in a display range for the on-site user in the virtual space.

15. The information processing apparatus according to claim 5,
wherein the processor is configured to display, when an action of a user indicated by an image related to the user displayed in the virtual space is different from a schedule of the user input to the scheduler, information indicating that the action of the user and the schedule do not agree with each other in a display range specified for the user in the virtual space.

16. The information processing apparatus according to claim 1,
wherein modes of display in the virtual space include a first mode in which images related to the users who constitute the user groups correlated with the regions are displayed, and a second mode in which images related to the plurality of users are displayed irrespective of the regions.

17. The information processing apparatus according to claim 1,
wherein the processor is configured to display, when a user has moved between the regions in the virtual space and a special user is included in users that constitute a user group correlated with a region as an origin of movement, an image related to the special user in a display range for the special user in the region as the origin of movement.

18. The information processing apparatus according to claim 1,
wherein the processor is configured to display, even when a second application that is different from a first application for displaying the virtual space is executed to make display in accordance with the second application, the virtual space along with the display made in accordance with the second application.

19. An information processing method comprising:
correlating user groups each constituted from users that are present at a plurality of locations in a real space with regions in a virtual space in which movement between the regions is allowed; and
displaying, when a user has moved between the regions in the virtual space, images related to users that constitute a user group correlated with a region as a movement destination in display ranges specified for the users, respectively, and display an image related to the user who has moved in a display range for the user who has moved.

20. A non-transitory computer readable medium storing an information processing program causing a computer to execute a process comprising:
correlating user groups each constituted from users that are present at a plurality of locations in a real space with regions in a virtual space in which movement between the regions is allowed; and
displaying, when a user has moved between the regions in the virtual space, images related to users that constitute a user group correlated with a region as a movement destination in display ranges specified for the users, respectively, and displaying an image related to the user who has moved in a display range for the user who has moved.
